(19) United States
(12) Patent Application Publication
(10) Pub. No.: US 2025/0251977 A1
(43) Pub. Date: Aug. 7, 2025

(54) Computer System and Computer-Implemented Method for Provisioning New Instances in Distributed Computing Systems

(71) Applicant: Shopify Inc., Ottawa (CA)

(72) Inventors: Adam PETRO, Waterloo (CA); Michael COONEY, Unionville (CA); Daniel KING, Orleans (CA); Anastasios MAKRIS, Windham, NH (US)

(73) Assignee: Shopify Inc., Ottawa (CA)

(21) Appl. No.: 18/433,788

(22) Filed: Feb. 6, 2024

(51) Int. Cl. G06F 9/50

(52) U.S. Cl. CPC G06F 9/5016; G06F 9/5083

(57) ABSTRACT

A computer system and computer-implemented method are provided for provisioning new instances in distributed computing systems. The method includes, responsive to a request to add a new instance in a distributed computing system having a plurality of instances, obtaining a list of identifiers from a currently running instance in the distributed computing system, the identifiers corresponding to software routines cached by the currently running instance; and loading, based on the identifiers, the software routines cached by the currently running instance into a cache on the new instance.

### TECHNICAL FIELD

The following relates generally to provisioning computing instances, in particular to provisioning new instances in distributed computing systems.

### BACKGROUND

Software may be deployed onto computing instances, sometimes referred to as containers or pods, to permit scaling, distributed processing, distributed computing, etc. When using containers for scaling, e.g., using Kubernetes™ or similar container orchestration systems, and the software being scaled includes large or many programs, the boot up times may be slow when creating new instances.

### BRIEF DESCRIPTION OF THE DRAWINGS

Embodiments will now be described with reference to the appended drawings wherein:

FIG. 1 is an example of a computing environment in which a distributed computing system is utilized.

FIG. 2 is an example of a multi-level cache configuration having a local cache and a hierarchical distributed cache.

FIG. 3a illustrates a new distributed computing instance being added to a distributed computing system having the distributed cache configuration shown in FIG. 2.

FIG. 3b illustrates the distributed computing system of FIG. 3a after adding the new distributed computing instance.

FIG. 4 is an example of a computing device operable to communicate in the computing environment.

FIG. 5 is a flow chart illustrating example operations for provisioning a new instance in a distributed computing system.

FIG. 6 is a flow chart illustrating example operations for loading software routines from a multi-level cache.

FIG. 7 is a flow chart illustrating example operations for initiating a request to add a new instance in a distributed computing system.

FIG. 8 is a flow chart illustrating example operations for selectively loading a sub-set of software routines to a new computing instance.

FIG. 9 is a flow chart illustrating example operations for obtaining a list of identifiers of software routines cached by a currently running instance.

### DETAILED DESCRIPTION

Scaling an application or service by adding new distributed computing pods, containers, or other types of instances, may be performed to meet increases or spikes in demand experienced by a platform such as a content streaming, e-commerce, or other software as a service (SaaS) platforms. These spikes may be expected or unexpected and may require prompt action, often automated. Software platforms that see spikes in demand for certain periods of time may automatically scale up a software application or service by adding instances (also referred to interchangeably herein as containers, pods, compute units, etc.) These new instances may be needed to meet the spike in demand and thus any delay in getting the new instance(s) online and functional could create delays, timeouts, or other irritating experiences for users or clients.

A computing platform may expect a spike in demand for an ephemeral event, which may require new virtualized instances to be created to service that short term event. Examples of such spikes may include, without limitation, flash sales, streaming or downloading events when a new software update (e.g., security patch) or media offering (e.g., new song or game) is released and a large demand is experienced or expected to occur for at least a period of time.

It has been recognized that instances being replicated typically include many (e.g., thousands) of software routines (also referred to interchangeably herein as functions, scripts, applications, etc.) that would need to be loaded on the new instance. However, for certain spikes in demand, it may only be a discrete number of the most recently, or most often, used programs that are immediately required to meet the demand.

Rather than obtain copies all software routines, the computer system described herein may obtain a list of identifiers (IDs) of the most recent, most used, most popular or other subset of the software routines that are cached on a currently running instance, to enable the new instance to prioritize loading this subset of software routines to increase the speed of the scale up process. In this way, the cache of the new instance may be “pre-heated”, that is, have its provisioning accelerated, based on the state of a currently running instance.

The subset of software routines may therefore be based on the activities of the currently running instances, which, in a distributed system, are expected to be the same or similar throughout each instance. It can be appreciated that, not every instance may have the same cache contents, however, due to the distribution of software routine runs, where a small number of modules make up a large number of the total software routine runs, each of the instances may have an accurate understanding of the “hot” modules. As such, any new instance may take the cache list from any instance and not suffer any type of warm up period. However, if one were to inspect the caches of the different instances, they may likely be slightly different.

In some scenarios, it may be desirable to only prime or pre-heat a cache of the new instance with the “top-n” rather than the whole cache contents. It is recognized that doing so may serve to reduce or limit overhead since there may be less to be transferred to the new instance and so, consequently, may serve to reduce or limit the risk of a malicious client performing operations to try and trigger new instances to be spawned (e.g., to handle a spike caused by a DoS/heavy bot traffic (different things though could be related or even the same)). That is, by only replicating the top n software routines, the system described herein may reduce the overhead of such a spike thereby potentially avoiding overload.

Additionally, once the new computing instance obtains the list of IDs, loading a subset of the software routines identified in the list may be prioritized to meet a spike in demand, with other routines added asynchronously thereafter.

In one aspect, there is provided a computer-implemented method, comprising: responsive to a request to add a new instance in a distributed computing system having a plurality of instances, obtaining a list of identifiers from a currently running instance in the distributed computing system, the identifiers corresponding to software routines cached by the currently running instance; and loading, based on the identifiers, the software routines cached by the currently running instance into a cache on the new instance.

In certain example embodiments, the list of identifiers may be obtained by sending a request to the currently running instance.

In certain example embodiments, the request may be sent randomly to one of a plurality of currently running instances.

In certain example embodiments, the request may be sent via a load balancer in the distributed computing system.

In certain example embodiments, the request may be sent by the load balancer to the currently running instance based on a metric.

In certain example embodiments, the metric may include a distance or geographical metric.

In certain example embodiments, the list of identifiers may correspond to most recently used software routines of a plurality of software routines.

In certain example embodiments, the list of identifiers may correspond to most often used software routines of a plurality of software routines.

In certain example embodiments, the method may further include adding the new instance to the distributed computing system after at least a minimum number of the software routines has been loaded into the cache on the new instance.

In certain example embodiments, the minimum number may include all of the software routines in the list of identifiers.

In certain example embodiments, the list of identifiers may be obtained from a first level of a multi-level cache.

In certain example embodiments, the method may further include loading at least one of the software routines from another level of the multi-level cache.

In certain example embodiments, the method may further include loading the at least one of the software routines from a third level of the multi-level cache responsive to determining that the at least one of the software routines is unavailable from a second level of the multi-level cache.

In certain example embodiments, the request to add the new instance may be initiated in response to detecting an increase in demand in usage of at least one of the software routines by client devices in a computing environment utilizing the distributed computing system.

In another aspect, there is provided a computer system comprising: at least one processor; and at least one memory, the at least one memory comprising processor executable instructions that, when executed by the at least one processor, cause the computer system to: responsive to a request to add a new instance in a distributed computing system having a plurality of instances, obtain a list of identifiers from a currently running instance in the distributed computing system, the identifiers corresponding to software routines cached by the currently running instance; and load, based on the identifiers, the software routines cached by the currently running instance into a cache on the new instance.

In certain example embodiments, the list of identifiers may be obtained by sending a request to the currently running instance.

In certain example embodiments, the system may further include processor executable instructions that, when executed by the at least one processor, cause the computer system to: add the new instance to the distributed computing system after at least a minimum number of the software routines has been loaded into the cache on the new instance.

In certain example embodiments, the list of identifiers may be obtained from a first level of a multi-level cache.

In certain example embodiments, the system may further include processor executable instructions that, when executed by the at least one processor, cause the computer system to: load at least one of the software routines from another level of the multi-level cache.

In another aspect, there is provided a computer-readable medium comprising processor executable instructions that, when executed by a processor of a computer system, cause the computer system to: responsive to a request to add a new instance in a distributed computing system having a plurality of instances, obtain a list of identifiers from a currently running instance in the distributed computing system, the identifiers corresponding to software routines cached by the currently running instance; and load, based on the identifiers, the software routines cached by the currently running instance into a cache on the new instance.

As such, when deployed within a distributed system that utilizes a multi-level distributed cache, e.g., a hierarchical multi-level cache, further time savings can be achieved when compiled versions are available from either a local “hot” cache or from a network attached storage such as another level of the multi-level cache that is available from the distributed cache. The deployment process may use the hierarchy to obtain the software routine(s) from the most readily available source or in the most readily obtainable state, in real-time during the scaling operation.

The result is a new computing instance that is more efficiently provisioned by being preloaded with a prioritized number of highly used software routines, without the need to compile them. Benefits may include a faster cache load that does not rely on running a pod voting process (e.g., in an expensive distributed system voting scheme), or a central registry of the “most used” or “most popular” software routines (which may quickly become out of date), from which to provision the cache on a newly instantiated computing unit.

The computing system described herein may be particularly advantageous when utilized in response to an ephemeral event (e.g., “flash sale”) where the infrastructure needs to scale out quickly to handle a large number of client/user requests. For example, in a flash sale, the typical flash sale may apply to a specific merchant or small number of merchants generating a large amount of user traffic in a short amount of time. A property of this is that a single merchant or small number of merchants may only use a small number of distinct software routines on their storefront.

Thus, the highly used software routines are more likely to be in the set preloaded on new computing instances at the time the system is rapidly scaled out to handle the traffic. Because they are quickly booted up and loaded with the highly used software routines, the software platform may be able to handle the traffic with much less lag.

For example, by provisioning the new instance in the way described herein, the provisioning may be quicker than compiling functions on the new instance, require less memory than loading all functions on the new instance, and be quicker than not loading any software routines on the new instance and going to the source each time a routine is invoked.

Similar principles apply to other applications such as meeting the demand for new downloads such as urgent security patches or in the event that a new song or game is released and is being downloaded at a high volume for a short period of time.

Additionally, the new computing instance may be held in a pending mode while the L1 cache is being preloaded and this amount of time may be varied by applying other controls. For example, a portion of the L1 cache may be loaded during the pending mode and the rest loaded asynchronously after entering the pod into the distribution system on the basis that a subset of the subset is more likely to be involved in the short spike of traffic in some instances.

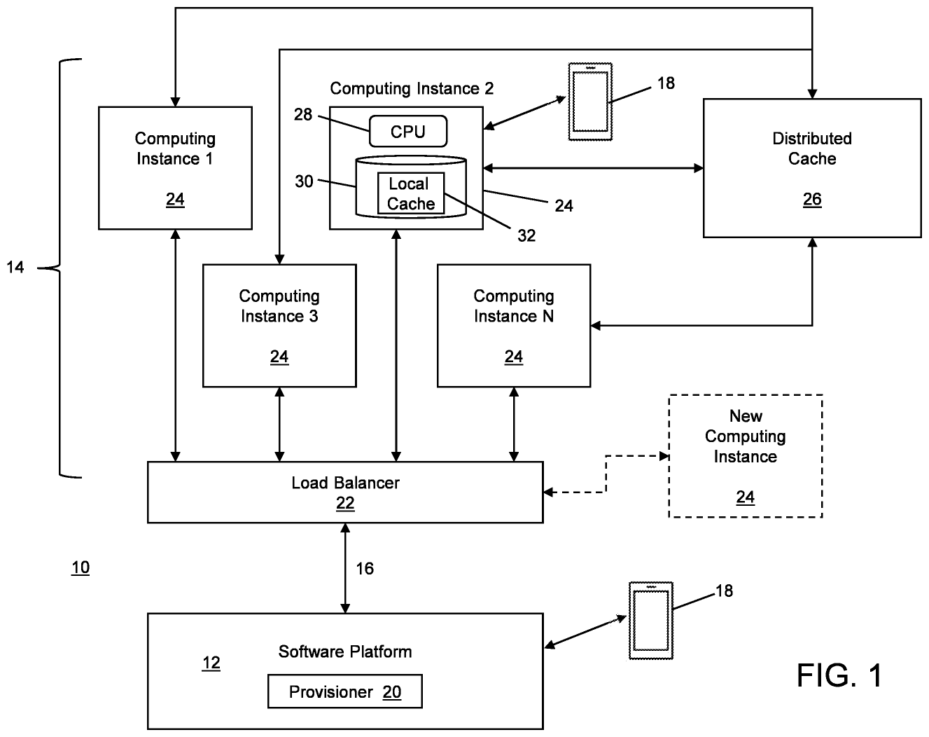

Turning now to the figures, FIG. 1a illustrates an example of a computing environment 10. The computing environment 10 in this example includes a software platform 12, which may be adapted as a SaaS platform such as, for example, an e-commerce platform, media distribution platform, security infrastructure platform, etc. The platform 12 includes, is in communication with, or is otherwise coupled to, a distributed computing system 14. The platform 12 and distributed computing system 14 may be coupled to each other via one or more communication connections 16, which may utilize one or more short- or long-range communication network protocols, described by way of example below.

The software platform 12, either directly or indirectly (via the distributed computing environment 14), may interact with various client devices 18, which may include user devices or devices operated by other computing entities. The client devices 18 may, for example, interact with the software platform 12 to obtain access to content or services and this may involve the software platform 12 directing or re-directing the client device 18 to a particular computing instance 24 in the distributed computing system 14.

The distributed computing system 14 in this example includes several computing instances 24, specifically numbered 1, 2, 3, . . . . N in FIG. 1. As such, it can be appreciated that the distributed computing system 14 may operate using any one or more computing instances 24 and this number may vary as the capacity afforded by the distributed computing system 14 is scaled up or down as required or instructed by the software platform 12. Also shown in FIG. 1 is a new computing instance 24, identified by dashed lines. The new computing instance 24 may be added to increase computing capacity for the software platform 12 using a utility or orchestration entity such as a provisioner 20. The provisioner 20 may refer to any unit, module, routine, application, function or computing element that is operable to execute a provisioning process for the software platform 12 to have the distributed computing system 14 add a new instance 24 to the system 14. The provisioner 20 is shown as a separate module for ease of illustration and its functionality may instead be implemented by the software platform 12 itself, an entity of or related to the distributed computing system 14 (e.g., load balancer 22 described below), or some other entity not shown in FIG. 1. It can be appreciated that the provisioner 20 or a related entity may be used to selectively remove computing instances 24 from the distributed computing system 14 as required or instructed.

The software platform 12 may interface with the distributed computing system 14 via a load balancer 22, which may refer to any unit, module, routine, application, function, or computing element that is operable to perform a load balancing function for the distributed computing system 14 to act as a facilitator to ensure that resources in the distributed computing system 14 (e.g., computing instances 24) are used as equally as possible.

In the example shown in FIG. 1, each computing instance 24 generally includes a CPU 28 (or other processing unit) and memory 30. The memory 30 includes at least one local cache 32, for example a readily accessible or “hot” cache. The local cache 32 may store software routines that the computing instance 24 is configured to execute for the software platform 12. The local cache 32 may have a fixed capacity such that the most used or most recently used software routines are kept in the cache while the least or lesser used software routines are pushed out of the cache and would be accessible from some other memory unit, such as the local memory 30 or some network-connected memory as discussed below.

The local cache 32 may include multiple levels, with such levels adopting a hierarchy. In this example, the local cache 32 is part of a multi-level cache structure that employs a distributed cache 26. The distributed cache 26 refers to any network- or cloud-accessible memory element that is made available to computing instances 24 in the distributed computing system 14. The distributed cache 26 may include multiple levels or tiers that may be utilized with the local cache 32 to load, store, and execute software routines on individual computing instances 24. The levels may be governed by a hierarchy. The new computing instance 24 shown in FIG. 1 may be connected to the distributed cache 26 once the provisioning process has been implemented.

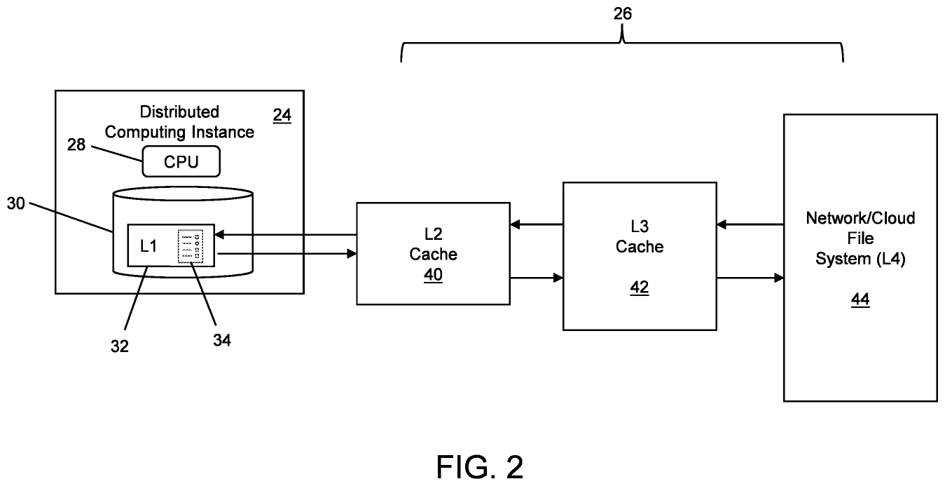

FIG. 2 provides an example of a multi-level cache that includes the local cache 32, referred to as “L1”, and a distributed cache 26 that includes three levels, namely a level 2 (L2) cache 40, a level 3 (L3) cache 42, and a network file system 44, which may also be referred to as a level 4 (L4) cache. The L1-L2-L3-L4 structure may follow a hierarchy or be governed by other relationships established by the distributed computing system 14.

In this example of a multi-level cache, the top level cache (L1) 32 lives in memory on an individual computing instance 24, while lower levels (L2, L3, L4) are part of the networked distributed computing system 14. That is, the lower levels (L2, L3, L4) may be available to access and download software routines from a cloud or network-attached storage, namely a memory element in the distributed cache 26. In this example, consider the four level structure:
L1 (32)—in-memory on an instance 24, ready to execute;
L2 (40)—fast ephemeral cache (e.g., Memcached™);
L3 (42)—durable cache, compiled bytecode (e.g., MySQL™, KateSQL™, Vitess™); and
L4 (44)—traditional/basic storage with uncompiled source code (e.g., Google Cloud Storage® bucket, Amazon S3® bucket).

The L4 cache 44 may receive uncompiled scripts or other software routines as they are deployed into the computing environment 10 and these software routines are compiled from source code to binary/bytecode and stored in a durable cache such as the L3 cache 42. When a computing instance 24 operates, it loads the software routines that are needed to memory (e.g., the L1 cache 32) and typically keeps a set number of software routines, e.g., based on a number of routines or fixed amount of memory available.

It has been recognized that each independent computing instance 24 that maintains its own L1 cache 32 may also maintain a list of identifiers (IDs) 34 corresponding to the software routines maintained in the L1 cache 32. This list of IDs 34 may inherently identify a “hot list” of most recently or most often used software routines by virtue of identifying software routines cached locally, which is found to also be indicative of being inclusive of the software routines that are required to meet a spike in demand in a distributed computing system 14, and which distributes similar tasks to multiple entities. The most recently used software routines may be the same or similar to the most often used software routines, but not necessarily since a spike in a less often used software routine over a short period could bump a less often used software routine into a “hot” list based on a short-term spike in activity.

Since each computing instance 24 would be experiencing the same or substantially similar demand, any L1 cache 32 in the distributed computing system 14 may be relied upon to prioritize the efficient provisioning process described herein for a new computing instance 24. It can be appreciated that the list of IDs 34 may take the form of any log or list of readily available software routines that are cached, readily available from memory 30 on one of the currently running computing instances 24, or at least indicative of the most recently or most often used software routines utilized by the currently running computing instances 24, from wherever they are accessed.

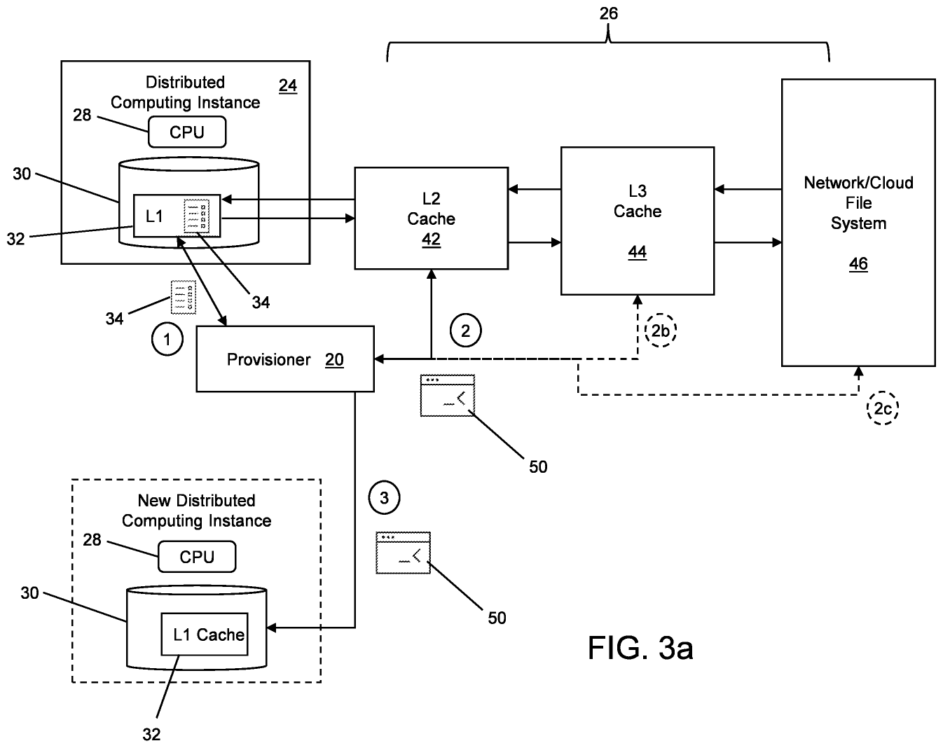

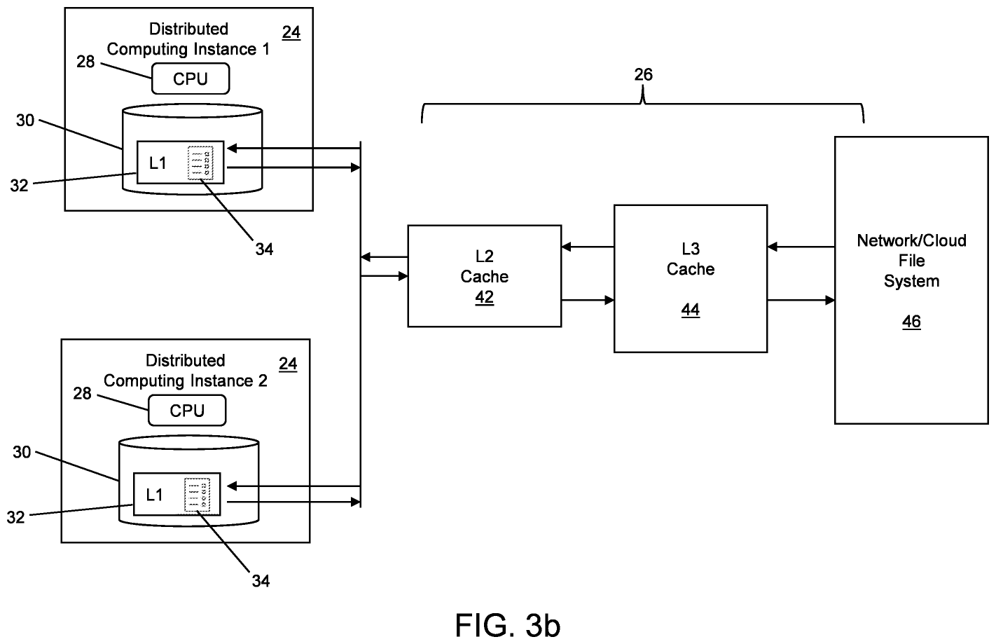

Referring now to FIG. 3a, when a new computing instance 24 is instantiated in a cluster of instances 24, as part of its initialization, bootup, or provisioning procedure, the new computing instance 24 requests the list of IDs 34 of the software routines 50 in the L1 cache 32 used by any of the currently running computing instances 24 at step 1, to determine what should be loaded into its L1 cache 32. The list 34 obtained at step 1 may then be used at step 2 to obtain one or more of the software routines 50 from the list 34 and load those software routines 50 in the L1 cache 32 of the new computing instance 32. As illustrated in FIG. 3a, step 2 may involve locating one or more of the software routines 50 from the most accessible or most easily accessible location within a multi-level distributed cache 26.

In this way, the new computing instance 24 may “pre-heat” based on the actual functions that are required to quickly serve the spike in demand, namely by leveraging the availability of the list of IDs 34 maintained by the currently running computing instances 24. For those software routines 50 not directly available from the L1 cache 32, at step 2, the provisioner 20 (on behalf of the new instance 24) may first check the ephemeral L2 cache 42 and then the durable L3 cache 44 if necessary to load the software routines 50. It may be noted that if unavailable from L2 or L3 caches 40, 44, the L4 cache 46 (i.e., a network or cloud-based file system) may be used to obtain uncompiled source code to compile the software routines 50.

The request for the list of IDs 34 of software routines 50 in the L1 cache 32 may be obtained in various ways. For example, the load balancer 22 of the distributed computing system 14 may be called to route the request, by random, or by applying some other metric such as distance (or regionality), usage/load, etc. Since the load balancer 22 levels or averages the distribution of tasks, any currently running computing instance 24 may be relied upon to obtain the list of IDs 34.

FIG. 3b illustrates the currently running and new computing instances 24 in operation post provisioning. At this stage, the two instances 24 may be used to scale up the service provided by the software platform 12. The software routines 50 may be accessed from either the L1 cache 32 on the instance 24 or the distributed cache 26, which may include the L2 cache 42, the L3 cache 44, and the network file system 46. Since the L1 cache 32 would be most likely to include the most often or most recently used software routines 50, the pre-heating stage shown in FIG. 3a may instantiate the new computing instance 24 much more quickly than if a static list is acquired or some other provisioning process used.

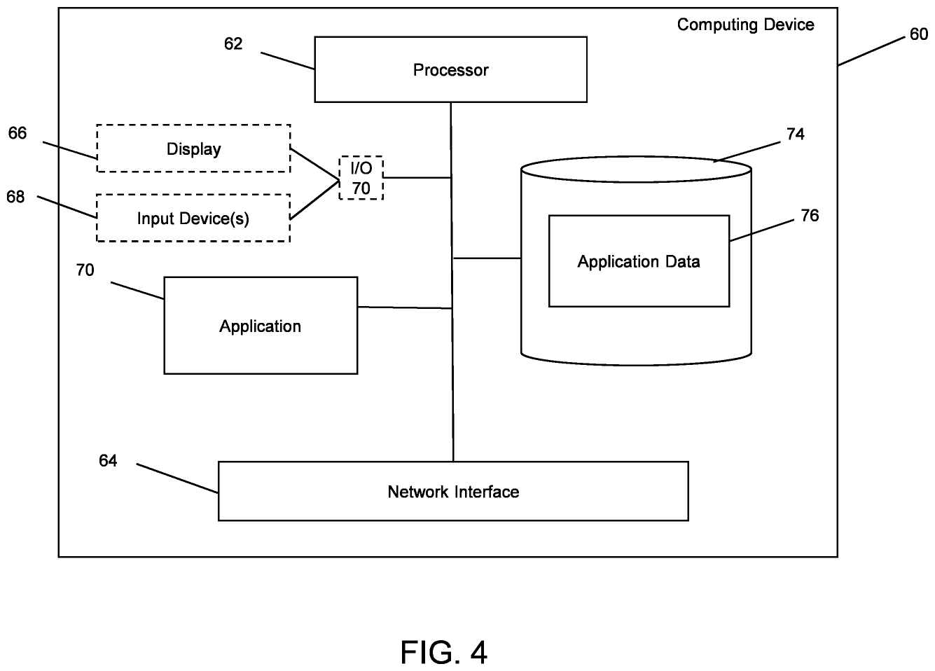

FIG. 4 shows an example of a computing device 60 which may be utilized by any of the entities shown in FIG. 1, for example, the software platform 12, client device 18, load balancer 22, or computing instance 24 and be adapted for the corresponding role of that entity. In this example, the computing device 60 includes one or more processors 62 (e.g., a microprocessor, microcontroller, embedded processor, digital signal processor (DSP), central processing unit (CPU), media processor, graphics processing unit (GPU) or other hardware-based processing units) and one or more network interfaces 64 (e.g., a wired or wireless transceiver device connectable to a network via a communication connection). Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device 60 also includes an application 70, a data store 74, and application data 76. It can be appreciated that the application 70 may represent an application provided by the software platform 12 to enable the computing device 60 to act as, for example, a client device 18 or as an internal device such as the provisioner 20. The application 70 may instead represent an application provided or used by the distributed computing system 14 to enable the client device 18 to act as a computing instance 24. The data store 74 may include an L1 cache 32 (not shown) when the computing device 60 is configured as a computing instance 24.

The data store 74 may represent a database or library or other computer-readable medium configured to store data and permit retrieval of such data. The data store 74 may be read-only or may permit modifications to the data. The data store 74 may also store both read-only and write accessible data in the same memory allocation. In this example, the data store 74 stores the application data 76 for the application 70 that is configured to be executed by the computing device 60 for a particular role or purpose.

While not delineated in FIG. 4, the computing device 60 includes at least one memory or memory device that can include a tangible and non-transitory computer-readable medium having stored therein computer programs, sets of instructions, code, or data to be executed by processor(s) 62. The processor(s) 62 and network interface(s) 64 are connected to each other via a data bus or other communication backbone to enable components of the computing device 60 to operate together as described herein. FIG. 4 illustrates examples of modules and applications stored in memory on the computing device 60 and executed by the processor(s) 62.

It can be appreciated that any of the modules and applications shown in FIG. 4 may be hosted externally and be available to the computing device 60, e.g., via a network interface 64. The data store 74 in this example stores, among other things, the application data 76 that can be accessed and utilized by the application 70. The data store 74 may additionally store one or more software routines 50, in an L1 cache 32 or in other types of memory. The application 70 may represent a software routine 50 when the computing device 60 is configured to act as a computing instance 24.

As shown in FIG. 4, the computing device 60 may, optionally, include a display 66 and one or more input device(s) 68 that may be utilized via an input/output (I/O) module 70. That is, such components may be omitted when the computing device 60 is configured to act as a computing instance 24.

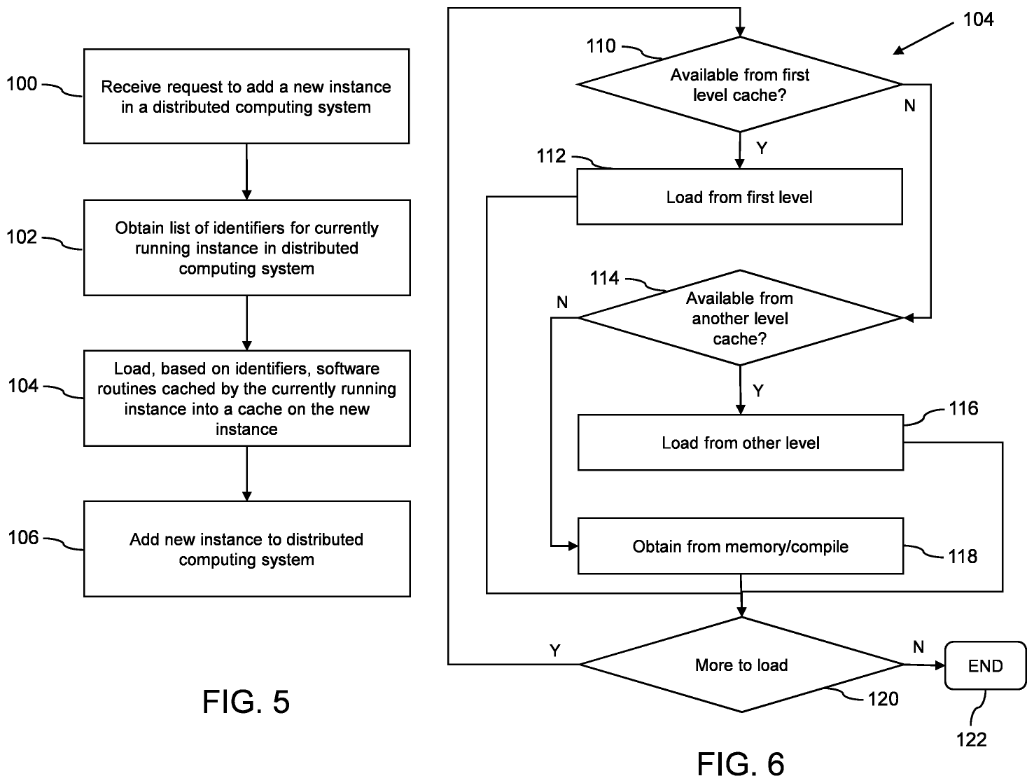

Referring now to FIG. 5, a flow chart is provided illustrating example operations for provisioning a new computing instance 24 in a distributed computing system 14. At block 100, the software platform 12, e.g., via the provisioner 20, may receive a request to add a new instance 24 in the distributed computing system 14 that is being utilized by the software platform 12. For example, the provisioner 20 may obtain data from the load balancer 22 or another entity in the computing environment 10 indicative of an increase in demand or an expected increase in demand for the computing resources provided by the computing instances 24.

At block 102, in response to a request to add a new computing instance 24, the provisioner 20 may obtain a list of IDs 34 for a currently running instance 24 in the distributed computing system 14. The list of IDs 34 may be obtained directly by the provisioner 20 or indirectly via some other entity such as the load balancer 22. The list of IDs 34 may be obtained from a random one of the currently running computing instances 24 or based on some other metric such as regionality (e.g., from a computing instance 24 in a same region), distance, availability, etc. By obtaining the list of IDs 34, the provisioner 20 is able to prioritize software routines 50 to be pre-loaded on the new computing instance 24 based on what is most recently and/or most often being utilized by the currently running computing instances 24 at that time. This leverages the existence and availability of the list of IDs 34 or an equivalent set of data indicative of same, such that the provisioner 20 may predict with a relatively high accuracy which software routines 50 should be immediately available to meet a spike or other increase in demand for the computing resources of the distributed computing system 14.

At block 104, the provisioner 20 may load (or have another utility or service load) software routines cached by the currently running computing instance 24, into a cache (e.g., L1 cache 32) on the new computing instance 24, based on the list of IDs 34. That is, the list of IDs 34 may be used to pre-load software routines to memory 30 of the new computing instance 24 such as in the local cache 32 by prioritizing all or a subset of all of the software routines 50 identified in the list 34.

At block 106, the new computing instance 24 may be added to the distributed computing system 14. Adding the new computing instance 24 may be held in a pending state while at least one or more of the software routines 50 is being loaded into the local cache 32 of the new computing instance 24, or an amount of time determined or set by the provisioner 20. That is, the new computing instance 24 may come online to scale up the distributed computing system 14 at an appropriate time when it is deemed ready to service its portion of the load. Such a determination may be made by or in conjunction with the load balancer 22 in the distributed computing system 14.

Referring now to FIG. 6, a flow chart is provided illustrating example operations for loading the software routines 50, e.g., as set out in block 104 of FIG. 5. At block 110, the provisioner 20 determines whether any of the software routines 50 from the list of IDs 34 (or a portion of the list) are available from a first level of a multi-level cache. In the example shown in FIGS. 1-3, this would include the local (L1) cache 32 on the currently running computing instance 24 from which the list of IDs 34 was obtained or some other portion of the local memory 30. If so, the targeted software routine 50 is loaded from the first level (local, L1) cache 32 at block 112. If not, the provisioner 20 may determine at block 114 whether the software routine 50 is available from another level of the cache, for example, from the L2 cache 40 or L3 cache 42. If so, the targeted software routine 50 is loaded from the other level at which it is located at block 116. It can be appreciated that at block 114, if multiple additional levels are available, e.g., in the distributed cache 26 as shown in FIG. 2, the provisioner 20 may check each level until it determines that a cached copy of the software routine 50 is not available. If not, the provisioner 20 may obtain the targeted software routine 50 by accessing the network or cloud-based file system 44 (L4 cache) and, if necessary, compiling the software routine 50 to ensure that the software routine 50 is pre-loaded onto the new computing instance 24.

At block 120, the provisioner 20 may determine if any additional software routines 50 are to be loaded. If so, the process may repeat at block 110. If not, the process ends at block 122.

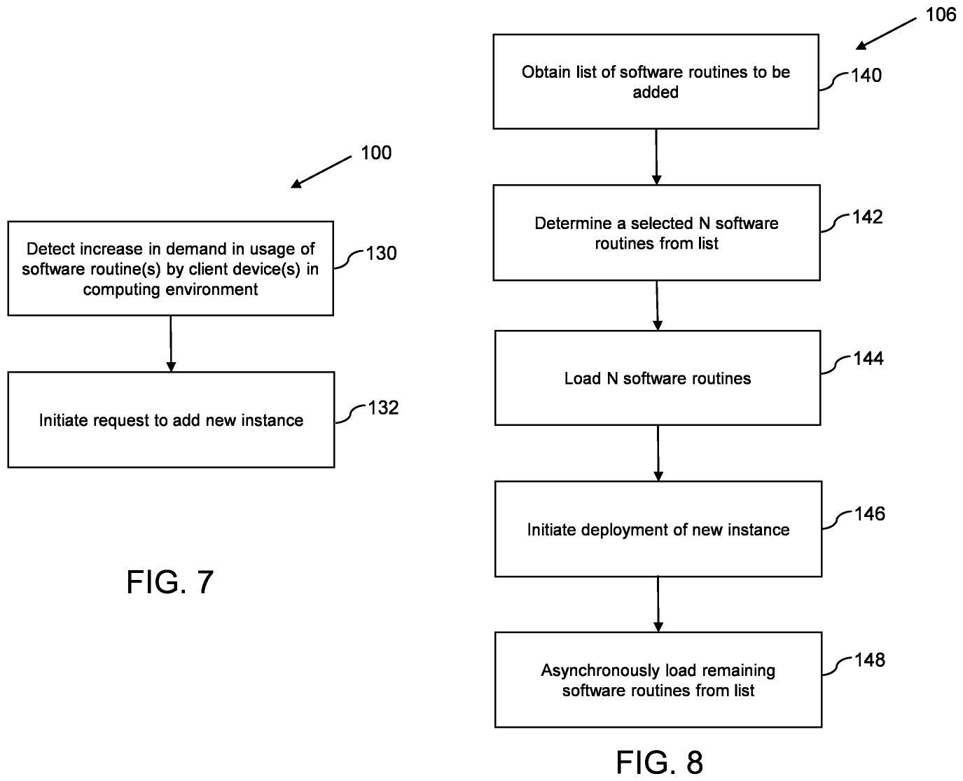

Referring now to FIG. 7, a flow chart is provided illustrating example operations for determining when to initiate adding a new computing instance 24 to the distributed computing system 14, e.g., as set out in block 100 of FIG. 5. At block 130, the provisioner 20 or another entity such as the load balancer 22 may detect an increase in demand in usage of one or more of the software routines 50 by client devices 18 in the computing environment 10, e.g., due to a new release, flash sale or other event that precipitates the demand.

The increase in demand may be detected in real-time or may be based on a schedule based on a prediction, safety buffer, or other metric utilized by the software platform 12 and/or distributed computing environment 14. For example, the software platform 12 may notify the load balancer 22 or provisioner 20 of an upcoming event that is expected to increase demand and have at least one new computing instance 24 scheduled to come online.

The provisioning process described herein allows the new computing instances 24 to come online more quickly and by utilizing fewer computing resources whether the scaling up is expected or is required dynamically in response to a detected event.

At block 132, the provisioner 20, load balancer 22 or other entity initiates the request to add the new computing instance 24, which may begin executing the process shown in FIG. 5 at block 100.

Referring now to FIG. 8, a flow chart is provided illustrating example operations for determining how to prioritize which software routines 50 are added to the new computing instance 24, e.g., when executing block 106 of FIG. 5. At block 140, the provisioner 20 obtains the list of software routines 50 to be added and determines a selected N of those software routines 50 from the list of IDs 34 at block 142. The “N” number of software routines 50 may be chosen based on various metrics, e.g., as a percentage of the number of IDs in the list of IDs 34, a fixed number (e.g., first 100), etc. The N number may be considered a “top N” number of software routines 50 or otherwise a selected N number. That is, N may be based on a fixed number, based on a number of software routines 50 used in determined/reasoned period of time (e.g., most used in the last 2 days), based on a number of software routines 50 that fit within a fixed memory size, based on some probability measure (e.g., top X % of software routines 50 used), or some other chosen metric.

At block 144, the top N software routines 50 are loaded into the local cache 32 of the new computing instance 24, which enables the new computing instance 24 to be deployed more quickly and efficiently at block 146. The remaining software routines 50 from the list of IDs 34 may be asynchronously loaded at block 148, e.g., after the new instance 24 is up and running in the distributed computing system 14. In this way, the most recently or often used, which are more likely to be necessary to meet a spike in demand can be available even more quickly than by loading the entire list of IDs 34. As such, controlled loading and deployment operations performed at block 106 may be implemented, particularly when the spike in demand is threatening to cause issues with the software platform 12 and the service(s) it is providing via the distributed computing system 14.

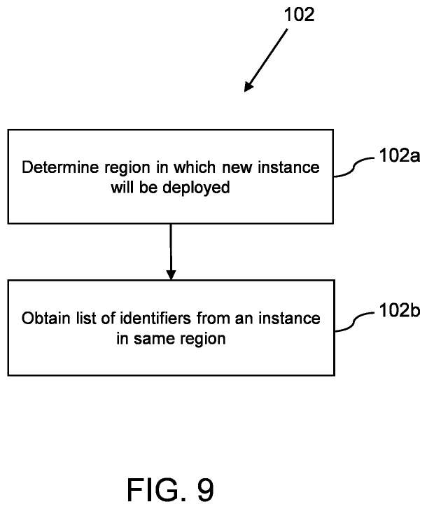

Referring now to FIG. 9, a flow chart is provided illustrating example operations for determining from where to obtain the list of IDs 34, e.g., as set out in block 102 of FIG. 5. At block 102a, the provisioner 20 may determine the region into which the new instance 24 will be deployed and at block 102b obtains the list of IDs 34 from a currently running instance 24 in the same region. For example, if the surge in demand is expected or being experienced within North America, a North American based computing instance 24 may be targeted to obtain the relevant list of IDs 24 for the new computing instance 24 that is being added.

Accordingly, rather than obtain copies all software routines, the computer system described herein may obtain a list of IDs of the most recent, most used, most popular or other subset of the software routines that are cached on a currently running instance, to enable the new instance to prioritize loading this subset of software routines to increase the speed of the scale up process. In this way, the cache of the new instance may be “pre-heated”, that is, have its provisioning accelerated, based on the state of a currently running instance.

While examples herein are in the context of software routines or functions-as-a-service, it can be appreciated that the principles described herein may be applied to other types of data, e.g., arbitrary data blobs and the like such as media files (song, game, etc.), data files, etc.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10 or any entity or component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method, comprising:
responsive to a request to add a new instance in a distributed computing system having a plurality of instances, obtaining a list of identifiers from a currently running instance in the distributed computing system, the identifiers corresponding to software routines cached by the currently running instance; and
loading, based on the identifiers, the software routines cached by the currently running instance into a cache on the new instance.

2. The method of claim 1, wherein the list of identifiers is obtained by sending a request to the currently running instance.

3. The method of claim 2, wherein the request is sent randomly to one of a plurality of currently running instances.

4. The method of claim 2, wherein the request is sent via a load balancer in the distributed computing system.

5. The method of claim 4, wherein the request is sent by the load balancer to the currently running instance based on a metric.

6. The method of claim 5, wherein the metric comprises a distance or geographical metric.

7. The method of claim 1, wherein the list of identifiers corresponds to most recently used software routines of a plurality of software routines.

8. The method of claim 1, wherein the list of identifiers corresponds to most often used software routines of a plurality of software routines.

9. The method of claim 1, further comprising adding the new instance to the distributed computing system after at least a minimum number of the software routines has been loaded into the cache on the new instance.

10. The method of claim 9, wherein the minimum number comprises all of the software routines in the list of identifiers.

11. The method of claim 1, wherein the list of identifiers is obtained from a first level of a multi-level cache.

12. The method of claim 11, further comprising loading at least one of the software routines from another level of the multi-level cache.

13. The method of claim 12, further comprising loading the at least one of the software routines from a third level of the multi-level cache responsive to determining that the at least one of the software routines is unavailable from a second level of the multi-level cache.

14. The method of claim 1, wherein the request to add the new instance is initiated in response to detecting an increase in demand in usage of at least one of the software routines by client devices in a computing environment utilizing the distributed computing system.

15. A computer system comprising:
at least one processor; and
at least one memory, the at least one memory comprising processor executable instructions that, when executed by the at least one processor, cause the computer system to:
responsive to a request to add a new instance in a distributed computing system having a plurality of instances, obtain a list of identifiers from a currently running instance in the distributed computing system, the identifiers corresponding to software routines cached by the currently running instance; and
load, based on the identifiers, the software routines cached by the currently running instance into a cache on the new instance.

16. The system of claim 15, wherein the list of identifiers is obtained by sending a request to the currently running instance.

17. The system of claim 15, further comprising processor executable instructions that, when executed by the at least one processor, cause the computer system to:
add the new instance to the distributed computing system after at least a minimum number of the software routines has been loaded into the cache on the new instance.

18. The system of claim 15, wherein the list of identifiers is obtained from a first level of a multi-level cache.

19. The system of claim 18, further comprising processor executable instructions that, when executed by the at least one processor, cause the computer system to:
load at least one of the software routines from another level of the multi-level cache.

20. A computer-readable medium comprising processor executable instructions that, when executed by a processor of a computer system, cause the computer system to:
responsive to a request to add a new instance in a distributed computing system having a plurality of instances, obtain a list of identifiers from a currently running instance in the distributed computing system, the identifiers corresponding to software routines cached by the currently running instance; and
load, based on the identifiers, the software routines cached by the currently running instance into a cache on the new instance.
